(19) United States
(12) Patent Application Publication
(10) Pub. No.: US 2008/0054595 A1
(43) Pub. Date: Mar. 6, 2008

(54) BICYCLE FRAME WITH A COUNTER-ROTATING FOUR BAR LINKAGE SYSTEM

(76) Inventor: Daniel T.F. LU, Taipei (TW)

Correspondence Address: PATENTTM.US, P. O. BOX 82788, PORTLAND, OR, 97282-0788, US

(21) Appl. No.: 11/469,756

(22) Filed: Sep. 1, 2006

(51) Int. Cl. B62K 5/00

(52) U.S. Cl. 280/284

(57) ABSTRACT

A bicycle frame with a counter-rotating four bar linkage system includes a front frame section, a rear frame section, and a shock absorber. The front frame section includes a top tube, a head tube, a seat tube, a bottom bracket, a down tube and a pivoting base formed on the down tube near the bottom bracket. The rear frame section is connected pivotally to the front frame section and has two seat stays, two chain stays, two dropouts, a connecting member, an upper linkage member, a lower linkage member and a parabolic virtual pivot (PVP). The PVP moves in a forwardly and upwardly parabolic trajectory and the dropouts of the rear frame section move in a nearly vertical trajectory when the rear frame section is pivoting.

### BACKGROUND OF THE INVENTION

1. Field of Invention

The present invention relates to a bicycle frame, and more particularly to a bicycle frame with a counter-rotating four bar linkage system that can optimize the suspension efficiency of the bicycle frame.

2. Description of the Related Art

With reference to FIG. 5, a conventional bicycle frame with a four bar linkage system comprises a front frame section (A), a rear frame section (B), an upper linkage member (D), a lower linkage member (E) and a shock absorber (C). The rear frame section (B) is mounted pivotally on the front frame (A) through the upper and lower linkage members (D, E). Both the upper and lower linkage members (D, E) have two pivots and an extension line defined by the pivots. The shock absorber (C) is mounted between the front frame section (A) and the upper linkage member (D). A virtual pivot point (VPP) is an intersection of the extension lines of the upper and lower linkage members (D, E). Because the upper and lower linkage members (D, E) are rotated in a same direction as shown in FIG. 5, the VPP moves in a backwardly and downwardly curved trajectory when the rear frame is pivoting. Accordingly, when the rider is pedaling heavily, the pedaling force of the rider is absorbed by the shock absorber (C) and the backward and downward movement of the VPP has a tendency to aggravate such interference between the rider and the rear frame section.

With reference to FIG. 6, another conventional bicycle frame with a four bar linkage system is similar to the bicycle frame in FIG. 5, except that the lower linkage member (E) is shorter than that in FIG. 5. The VPP of this conventional bicycle frame as shown in FIG. 6 also moves in a backwardly and downwardly curved trajectory when the rear frame is pivoting and the pedaling force of the rider is also absorbed by the shock absorber (C). The backward and downward movement of VPP also has a tendency to aggravate such interference between the rider and the rear frame.

With reference to FIG. 7, another conventional bicycle frame with a counter-rotating four bar linkage system comprises a front frame section (A), a rear frame section (B), an upper linkage member (D), a lower linkage member (E) and a shock absorber (C). Because the upper and lower linkage members (D, E) are rotated counter to each other as shown in FIG. 7, the VPP moves in a forwardly curved trajectory. Accordingly, the disadvantage of the pedaling force of the rider being absorbed by the shock absorber (C) has been largely reduced. However, the position of the rear wheel axle moves in a backwardly curved trajectory when the rear frame section (B) is pivoting and this causes a stretched chain length and results in problems of locking up the rear frame section (B) when the rear brake is activated. The stretched chain also pulls back the pedals when the rear frame section (B) is moving, thus interferes the rider's pedaling and handling. Structure wise, the short lower linkage member (E) also causes problems of assembling tolerance and wobble of the rear frame section (B).

To overcome the shortcomings, the present invention provides a bicycle frame with a counter-rotating four bar linkage system to mitigate or obviate the aforementioned problems.

### SUMMARY OF THE INVENTION

The primary objective of the present invention is to provide a bicycle frame with a counter-rotating four bar linkage system that can optimize the suspension efficiency of the bicycle frame and minimize the interference between the rider and the rear frame section, under rider's pedaling and braking, and under the rear frame section's movement.

A bicycle frame with a counter-rotating four bar linkage system comprises a front frame section, a rear frame section, and a shock absorber. The front frame section comprises a top tube, a head tube, a seat tube, a bottom bracket, a down tube and a pivoting base. The top tube has a front end and a rear end. The head tube is connected to the front end of the top tube. The seat tube is connected to the rear end of the top tube and has a lower end. The bottom bracket is mounted transversely on the lower end of the seat tube. The down tube has a front end connected to the head tube and a rear end connected to the bottom bracket. The pivoting base is formed on the down tube near the bottom bracket.

The rear frame section is connected pivotally to the front frame section and has two seat stays, two chain stays, two dropouts, a connecting member, an upper linkage member, a lower linkage member and a parabolic virtual pivot (PVP). The seat stays are extended bilaterally over the seat tube and each has a front end and a rear end. The chain stays have a front end and a rear end. The dropouts are mounted on the rear ends of the seat stays and the chain stays. The connecting member is mounted on the front ends of the chain stays and extended forwardly near the bottom bracket. The upper linkage member is mounted pivotally on the front ends of the seat stays and the seat tube near the top tube and has an extension line extended to a position that is between the pivoting base and the connecting member. The lower linkage member is mounted pivotally on the connecting member and the pivoting base and has an extension line. The PVP is an intersection of the extension lines of the upper and lower linkage members. The PVP moves in a forwardly and upwardly parabolic trajectory and the dropouts of the rear frame move in a nearly straight trajectory when the rear frame is pivoting.

The shock absorber is mounted between the top tube and the front ends of the seat stays.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a bicycle frame with a counter-rotating four bar linkage system in accordance with the present invention;

FIG. 2 is an enlarged perspective view of the bicycle frame with a counter-rotating four bar linkage system in FIG. 1;

FIG. 3 is a side view of the bicycle frame with a counter-rotating four bar linkage system in FIG. 1;

FIG. 4 is an operational side view of the bicycle frame with a counter-rotating four bar linkage system in FIG. 1 with the rear frame section being pivoting;

FIG. 5 is an operational side view of a conventional bicycle frame with a four bar linkage system in accordance with the prior art with the rear frame section being pivoting;

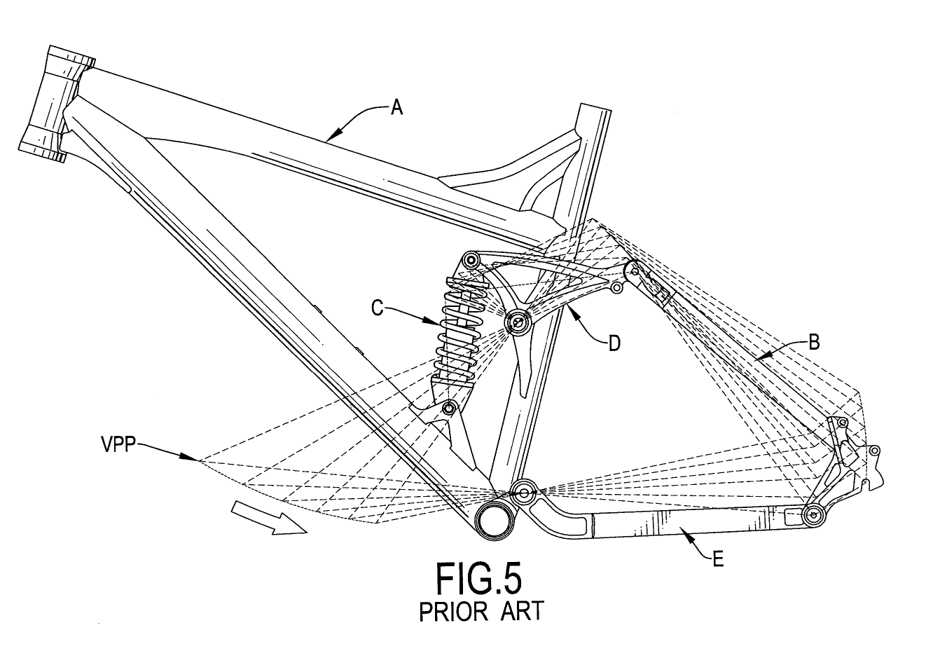

FIG. 6 is an operational side view of another conventional bicycle frame with a four bar linkage system in accordance with the prior art with the rear frame section being pivoting; and

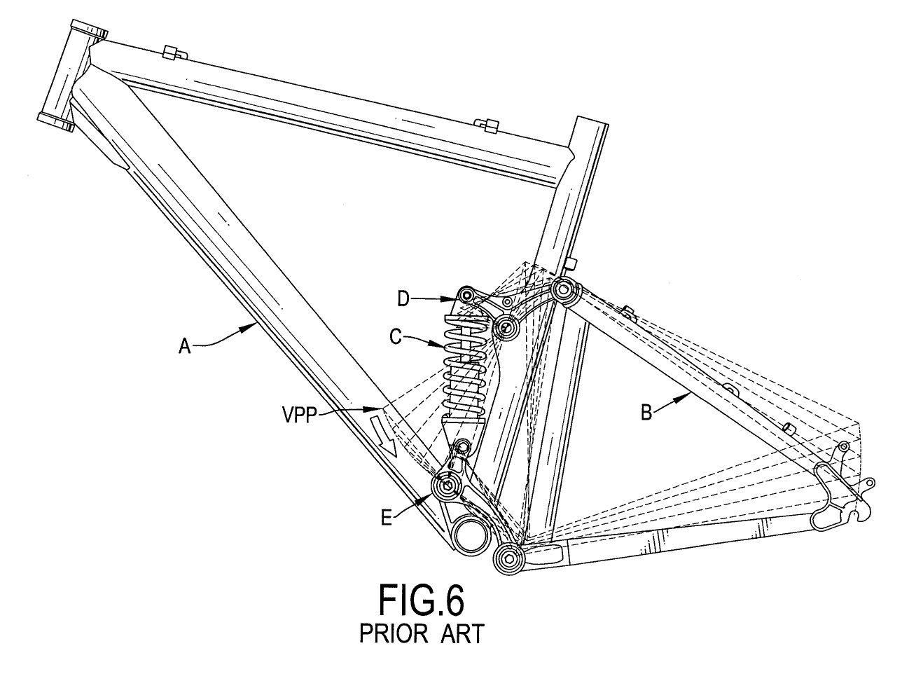

FIG. 7 is an operational side view of a conventional bicycle frame with a counter-rotating four bar linkage system in accordance with the prior art with the rear frame section being pivoting.

### DETAILED DESCRIPTION OF THE INVENTION

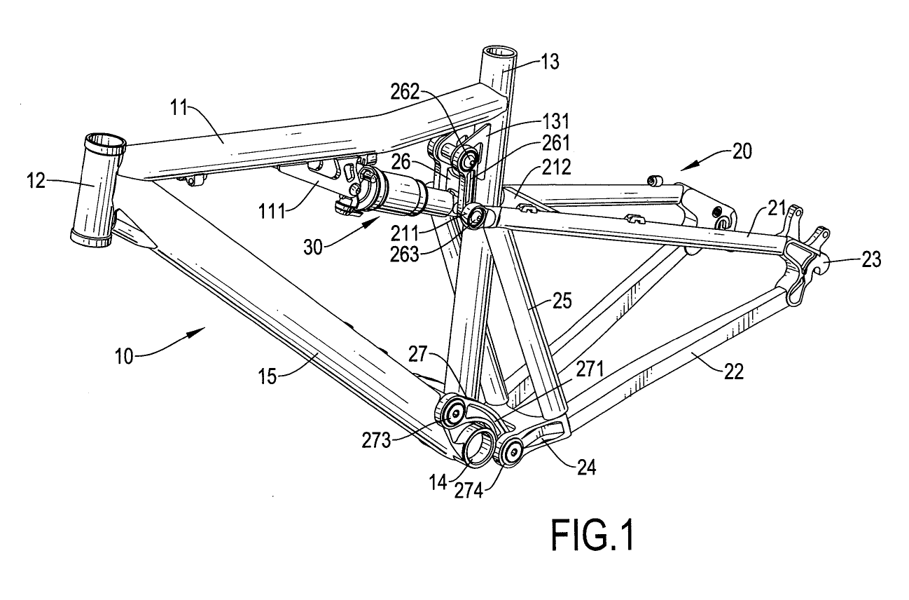

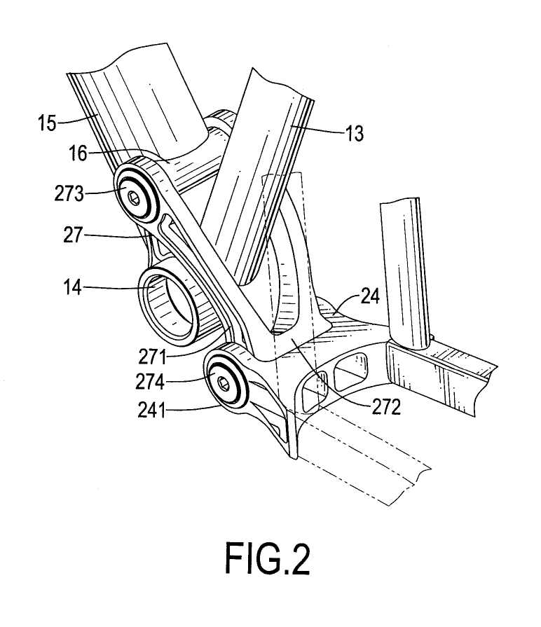

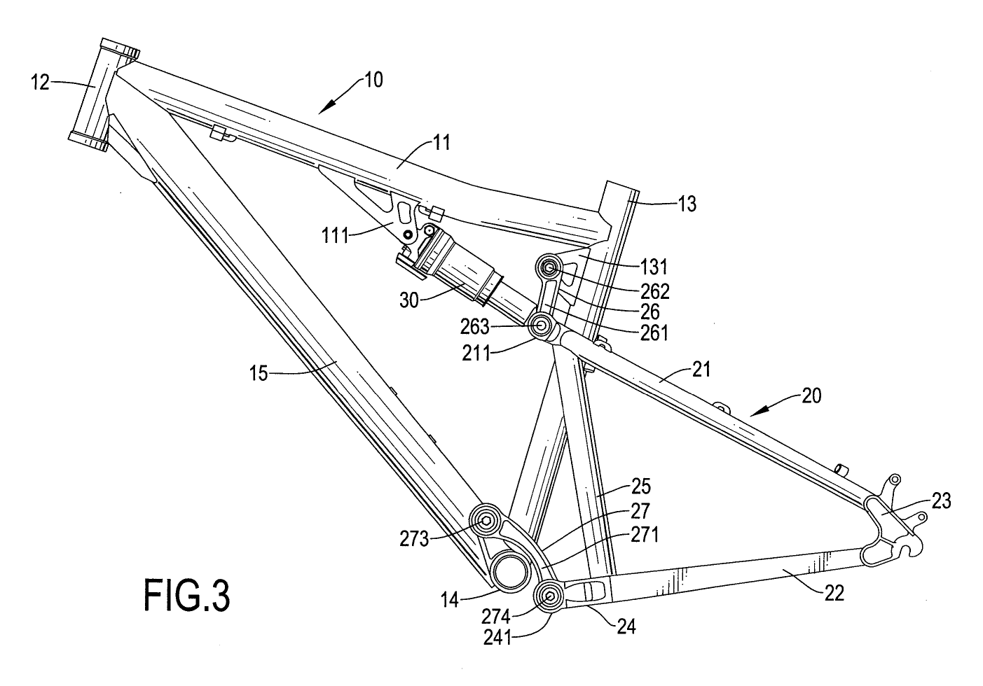

With reference to FIGS. 1, 2 and 3, a bicycle frame with a counter-rotating four bar linkage system in accordance with the present invention comprises a front frame section (10), a rear frame section (20) and a shock absorber (30).

The front frame section (10) has a top tube (11), a head tube (12), a seat tube (13), a bottom bracket (14), a down tube (15) and a pivoting base (16). The top tube (11) is substantially horizontal and has a front end, a rear end, a middle segment and a mounting bracket (111). The mounting bracket (111) is mounted downwardly on the middle segment of the top tube (11) for connecting with the shock absorber (30). The head tube (12) is connected to the front end of the top tube (11) for mounting around a front fork of the bicycle. The seat tube (13) is connected to the rear end of the top tube (11) for mounting a saddle of the bicycle and has an upper end, a lower end and a mounting bracket (131). The mounting bracket (131) is mounted on the seat tube (13) near the top tube (11). The bottom bracket (14) is mounted transversely on the lower end of the seat tube (13). The down tube (15) has a front end connected to the head tube (12) and a rear end connected to the bottom bracket (14). The pivoting base (16) is formed integrally on the down tube (15) near the bottom bracket (14) and corresponds to a chainwheel of the bicycle.

The rear frame section (20) is connected pivotally to the front frame section (10) and has two seat stays (21), a mounting bar (212), two chain stays (22), two dropouts (23), a connecting member (24), two front stays (25), an upper linkage member (26), a lower linkage member (27) and a parabolic virtual pivot (PVP). The seat stays (21) are extended bilaterally over the seat tube (13) and each has a front end (211), a rear end and an extension line along the seat stays (21). The mounting bar (212) is mounted transversely between the seat stays (21) near the front ends (211) of the seat stays (21) for mounting a rear brake. Each chain stay (22) has a front end and a rear end. The dropouts (23) are mounted on the rear ends of the seat stays (21) and the chain stays (22) for carrying a rear wheel axle. The connecting member (24) is mounted on the front ends of the chain stays (22) and has two lugs (241) extended forwardly near the bottom bracket (14). Each front stay (25) has an upper end connected to one of the seat stays (21) near the front end (211) and a lower end connected to the front end of one of the chain stays (22).

The upper linkage member (26) is H-shaped and has two side bars (261), a connecting bar, an upper pivot (262), a lower pivot (263) and an extension line. The side bars (261) are parallel to each other and each has an upper end and a lower end. The connecting bar is connected integrally to the side bars (261). The upper pivot (262) is mounted through the upper ends of the side bars (261) and attaches the upper ends of the side bars (261) pivotally on the mounting bracket (131) on the seat tube (13). The lower pivot (263) is mounted through the lower ends of the side bars (261) and attaches the lower ends of the side bars (261) pivotally on the front ends (211) of the seat stays (21). The extension line is defined by the upper and lower pivots (262, 263) and is extended to a position that is between the pivoting base (16) and the connecting member (24) before the rear frame section (20) is pivoting.

The lower linkage member (27) is U-shaped and has two side bars (271), a connecting tube (272), a front pivot (273), a rear pivot (274) and an extension line. The side bars (271) are curved and each has a front end and a rear end. The connecting tube (272) is connected integrally to the rear ends of the side bars (271). The front pivot (273) is mounted through the front ends of the side bars (271) and attaches the front ends of the side bars (271) pivotally on the pivoting base (16) on the down tube (15). The rear pivot (274) is mounted through the connecting tube (272) and attaches the connecting tube (272) pivotally between the lugs (241) of the connecting member (24). The extension line is defined by the front and rear pivots (273, 274).

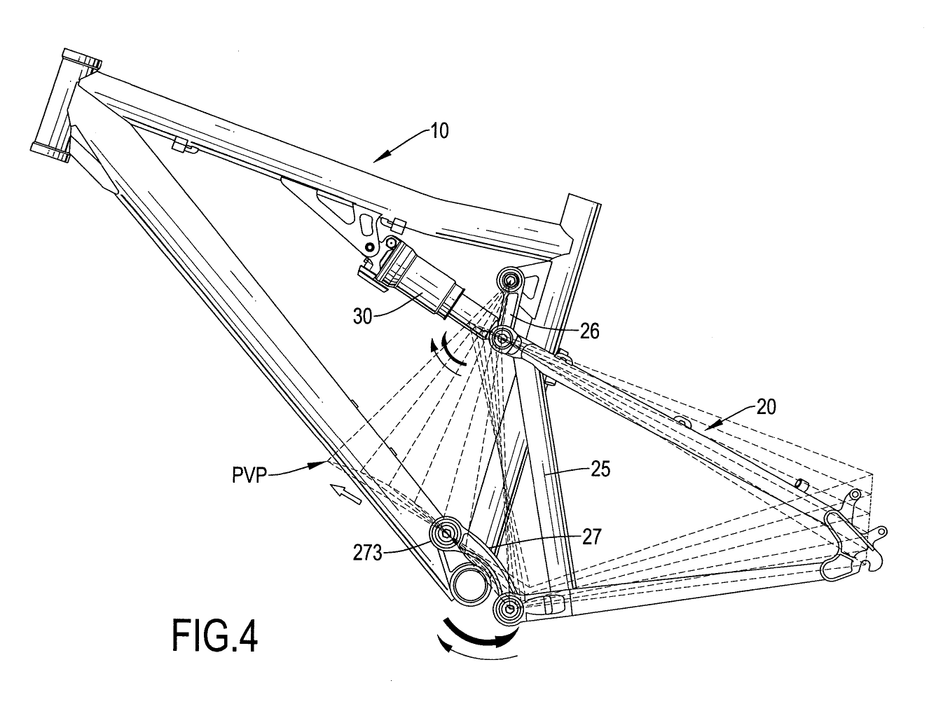

With further reference to FIG. 4, the PVP is an intersection of the extension lines of the upper and lower linkage members (26, 27). The PVP moves in a forwardly and upwardly parabolic trajectory and the dropouts (23) of the rear frame section (20) move in a nearly vertical trajectory when the rear frame section (20) is pivoting.

The shock absorber (30) is mounted generally along the extension line of the seat stays (21) and has a front end and a rear end. The front end of the shock absorber (30) is mounted on the mounting bracket (111) on the top tube (11). The rear end of the shock absorber (30) is mounted on the front ends (211) of the seat stays (21).

With reference to FIG. 4, the bold arrow represents the rotating directions of the upper and lower linkage members (26, 27) when a rider is pedaling. The thin arrow represents the rotating directions of the upper and lower linkage members (26, 27) when the suspension of the shock absorber (30) is activated. Because the upper and lower linkage members (26, 27) are rotated counter to each other, the PVP moves in a forwardly and upwardly parabolic trajectory when the suspension of the shock absorber (30) is activated. Accordingly, when a rider is pedaling or changing his riding position, bounce of the rear frame section (20) can be reduced and the pedaling force of the rider will not be absorbed by the shock absorber (30).

In addition, the dropouts (23) of the rear frame section (20) move in a nearly vertical trajectory when the suspension of the shock absorber (30) is activated. So the rear frame section (20) can not be locked up when rear brake is activated, as well as the pedals are not pulled back when the rear frame section (20) is moving.

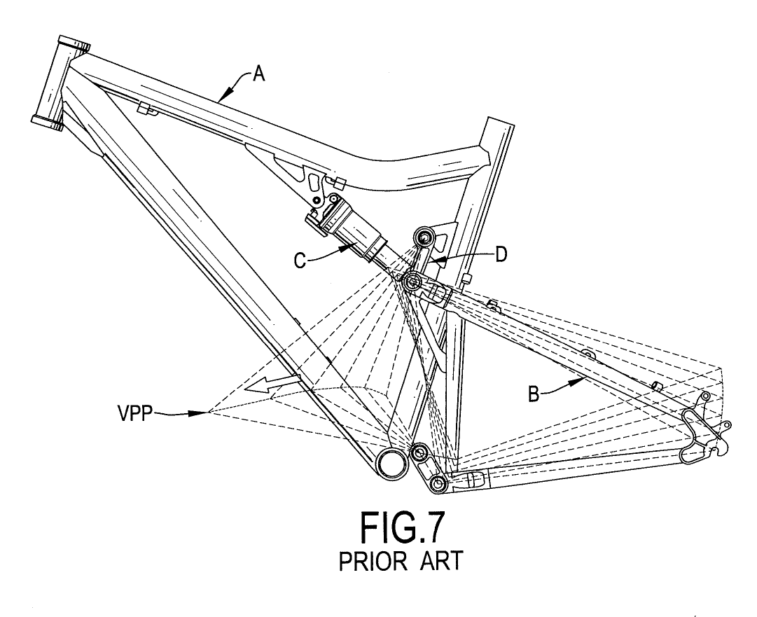

Furthermore, with the lower connecting member (27) being longer compared to that of the conventional bicycle frame in FIG. 7, wobble and assembling tolerance of the rear frame section (20) can be reduced.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A bicycle frame with a counter-rotating four bar linkage system comprising
a front frame section comprising
a top tube having a front end and a rear end;
a head tube being connected to the front end of the top tube;
a seat tube being connected to the rear end of the top tube and having a lower end;
a bottom bracket being mounted transversely on the lower end of the seat tube;
a down tube having a front end connected to the head tube and a rear end connected to the bottom bracket; and
a pivoting base being formed on the down tube near the bottom bracket;
a rear frame section being connected pivotally to the front frame section and having
two seat stays being extended bilaterally over the seat tube and each having a front end and a rear end;
two chain stays having a front end and a rear end;
two dropouts being mounted on the rear ends of the seat stays and the chain stays;
a connecting member being mounted on the front ends of the chain stays and extended forwardly near the bottom bracket;
an upper linkage member being mounted pivotally on the front ends of the seat stays and the seat tube near the top tube and having two pivots and an extension line defined by the pivots, wherein the extension line is extended to a position that is between the pivoting base and the connecting member before the rear frame section is pivoting;
a lower linkage member being mounted pivotally on the connecting member and the pivoting base and having two pivots and an extension line defined by the pivots; and
a parabolic virtual pivot (PVP) being an intersection of the extension lines of the upper and lower linkage members, wherein the PVP moves in a forwardly and upwardly parabolic trajectory and the dropouts move in a nearly vertical trajectory when the rear frame section is pivoting; and
a shock absorber being mounted between the top tube and the front ends of the seat stays.

2. The bicycle frame with a counter-rotating four bar linkage system as claimed in claim 1, wherein
the seats stays have an extension line along the seat stays; and
the shock absorber is mounted generally along the extension line of the seat stays.

3. The bicycle frame with a counter-rotating four bar linkage system as claimed in claim 2 wherein
the top tube further has a middle segment and a mounting bracket mounted downwardly on the middle segment of the top tube and pivotally connected with the shock absorber.

4. The bicycle frame with a counter-rotating four bar linkage system as claimed in claim 3, wherein
the seat tube further has a mounting bracket mounted forwardly on the seat tube near the top tube and pivotally connected with the upper linkage member.

5. The bicycle frame with a counter-rotating four bar linkage system as claimed in claim 4, wherein
the rear frame section further has
two front stays and each having an upper end connected to one of the seat stays near the front end of the seat stay and a lower end connected to the front end of one of the chain stays; and
a mounting bar mounted transversely between the seat stays near the front ends of the seat stays.

6. The bicycle frame with a counter-rotating four bar linkage system as claimed in claim 5, wherein
the upper linkage member is H-shaped and has two side bars and a connecting bar; and
the side bars are parallel to each other and the connecting bar is connected integrally to the side bars.

7. The bicycle frame with a counter-rotating four bar linkage system as claimed in claim 6, wherein
the lower linkage member is U-shaped and has two side bars and a connecting tube;
the side bars are curved and each has a front end and a rear end; and
the connecting tube is connected integrally to the rear ends of the side bars.

8. The bicycle frame with a counter-rotating four bar linkage system as claimed in claim 7, wherein
the connecting member further has two lugs extended forwardly near the bottom bracket; and
the connecting tube of the lower linkage member is mounted between the lugs of the connecting member.
